(19) United States
(12) Patent Application Publication
(10) Pub. No.: US 2020/0277014 A1
(43) Pub. Date: Sep. 3, 2020

(54) Game Mount System for Use With Snow Bike

(71) Applicant: Stallion Sport Limited, San Po Kong (HK)

(72) Inventor: Ying Kin Ho, Kowloon (HK)

(73) Assignee: Stallion Sport Limited, San Po Kong (HK)

(21) Appl. No.: 16/289,373

(22) Filed: Feb. 28, 2019

(51) Int. Cl. B62J 7/06; F16M 11/04; B60R 11/02

(52) U.S. Cl. CPC B62J 7/06; F16M 11/041; B60R 2011/001; B60R 11/0241; F16M 11/043

(57) ABSTRACT

A method of playing a video game on a smartphone using a snow bike is provided. A holder is mounted to the front frame of a snow bike in a manner where the holder is positioned at a central portion of the front frame, and a smartphone is positioned in the holder. Two conductive button assemblies are provided, each having a conductive button, a conductive suction cup, and a connecting wire that connects the conductive button to the conductive suction cup. Each conductive button is clipped onto a separate handlebar, and each conductive suction cup is attached to the touchscreen of the smartphone. The user then actuates a video game on the smartphone and manipulates the steering assembly to play the video game.

### BACKGROUND OF THE INVENTION

### 1. Field of the Invention

The present invention relates to a system for allowing a smartphone to be mounted on to a steering frame of a conventional snow bike so that the steering frame of the snow bike can be used to manipulate the smartphone for use in playing a game.

### 2. Description of the Prior Art

One of the most popular activities associated with a hand-held smartphone are games that can be downloaded and played by the user. The user would hold the smartphone using both hands, with a finger from each hand pressing on the screen of the smartphone, and then manipulate the smartphone to play the game by turning the smartphone. Many of these games include action games where a user is required to navigate a course or a roadway, or through obstacles or battles. It would be beneficial to provide these users with a more life-like or realistic experience, such that the user can actually simulate the experience of navigating through the course, roadway, obstacles or battle.

Separately, snow bikes are very popular for use in the winter or at ski resorts where there is enough snow to ride these snow bikes. Unfortunately, these snow bikes can only be used with snow, and when there is no snow (e.g., such as in the summer), most owners of snow bikes usually park the snow bikes in the garage and do not use them. It would be beneficial to find a new and additional use for snow bikes.

### SUMMARY OF THE DISCLOSURE

The present invention provides a system and a method for using a snow bike to provide a more realistic simulation of a game experience, by providing a mounting system for allowing a conventional smartphone to be mounted to a steering assembly of a conventional snow bike so that a user can ride the snow bike and play a game on the smartphone by steering the steering assembly of the snow bike.

In order to accomplish the objects of the present invention, the present invention provides a method of playing a video game on a smartphone using a snow bike. The snow bike has a main body, at least one sled extending from the main body, and a front frame provided on the main body, the front frame having a steering assembly that includes a central portion and two handlebars extending from opposite ends of the central portion. A holder is mounted to the front frame in a manner where the holder is positioned at the central portion, and a smartphone is positioned in the holder. Two conductive button assemblies are provided, each having a conductive button, a conductive suction cup, and a connecting wire that connects the conductive button to the conductive suction cup. Each conductive button is clipped onto a separate handlebar, and each conductive suction cup is attached to the touchscreen of the smartphone. The user then actuates a video game on the smartphone and manipulates the steering assembly to play the video game. The user can ride on the main body of the snow bike and grip the handlebar while steering the steering assembly.

### BRIEF DESCRIPTION OF THE DRAWINGS

FIG. 1 is a perspective view of a conventional snow bike shown with the mounting system of the present invention installed on the steering assembly, and with a smartphone secured on the mounting system.

FIG. 2 is an enlarged perspective view of the steering assembly of FIG. 1 showing the mounting system and the smartphone.

FIG. 3 is an exploded perspective view of the mounting system of FIG. 1.

FIG. 4 is an exploded perspective of a conductive button assembly for the mounting system of FIG. 1.

FIG. 5 illustrates the steering assembly and mounting system of FIG. 1 showing the steering assembly turned to one side.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

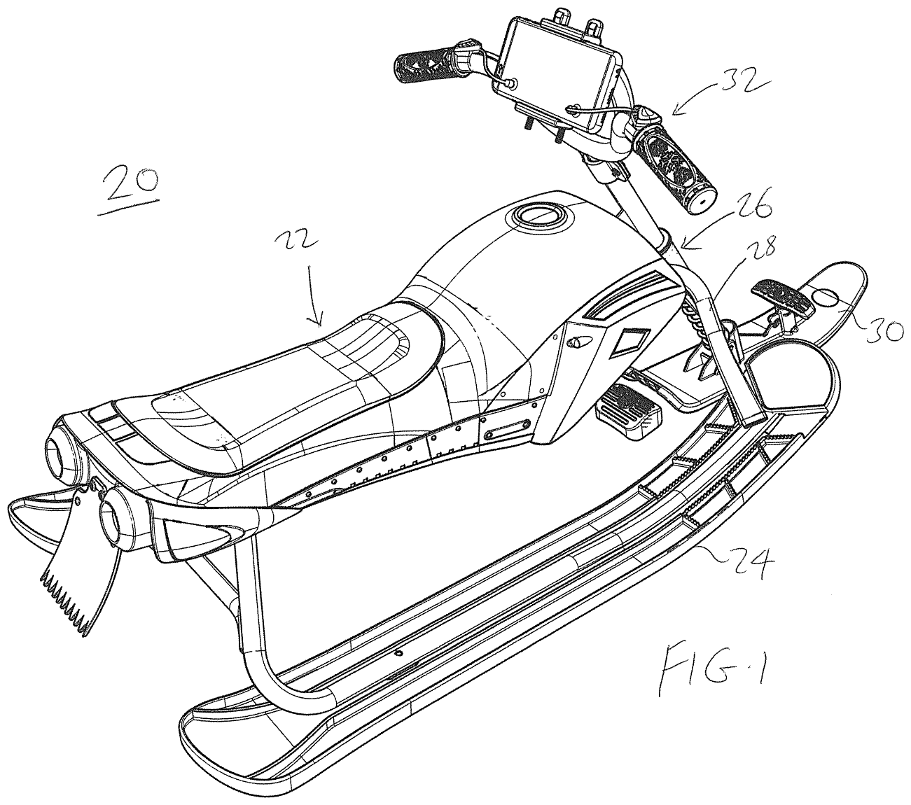

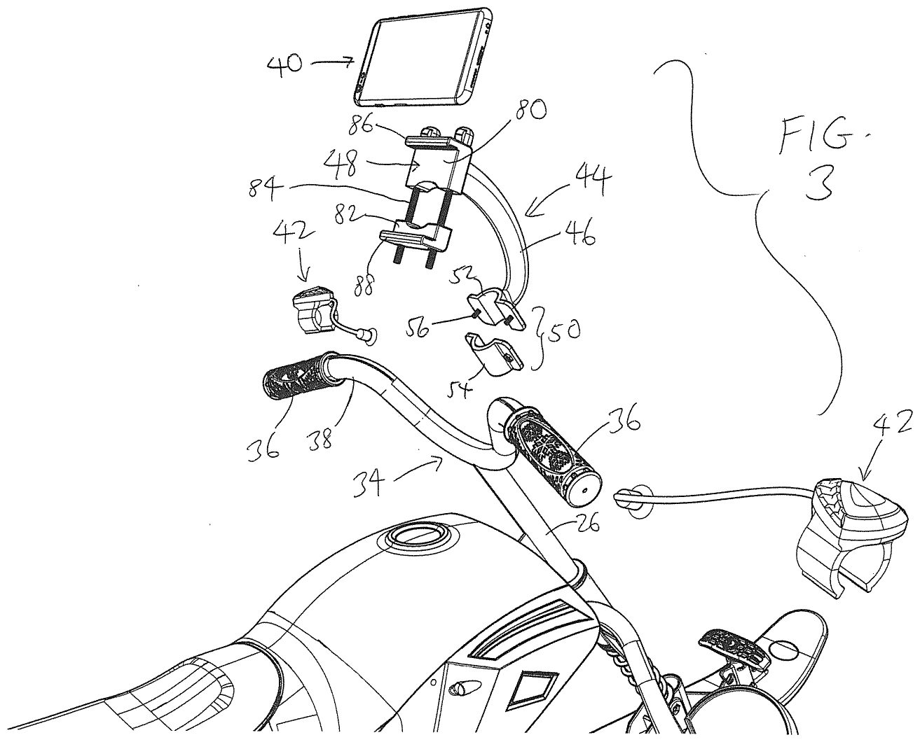

Referring to FIGS. 1-3, a conventional snow bike 20 has a main body 22 which houses the electronics and power supply for the snow bike, and which also functions as a seat for one or two riders. Two sleds 24 extend from below the main body 22. A front frame 26 is secured to the front of the main body 22, and has a left fork that connects to the left sled, and a right fork 28 that connects to the right sled 24. A front ski 30 extends from the bottom of the front frame 26, and a steering assembly 32 is provided at the top of the front frame 26. The steering assembly 32 has a generally U-shaped central portion 34 and two handlebars 38 extending from opposite ends of the central portion 34. Each handlebar 38 has a grip 36. The central portion 34 is attached to the top of the front frame 26.

A mounting system is removably secured to the front frame 26 at the location of the central portion 34 so that a smartphone 40 can be mounted at the location of the U-shaped opening in the central portion 34. The mounting system has two conductive button assemblies 42, and a mount 44 that includes a curved bar 46, a holder 48 and clamping section 50.

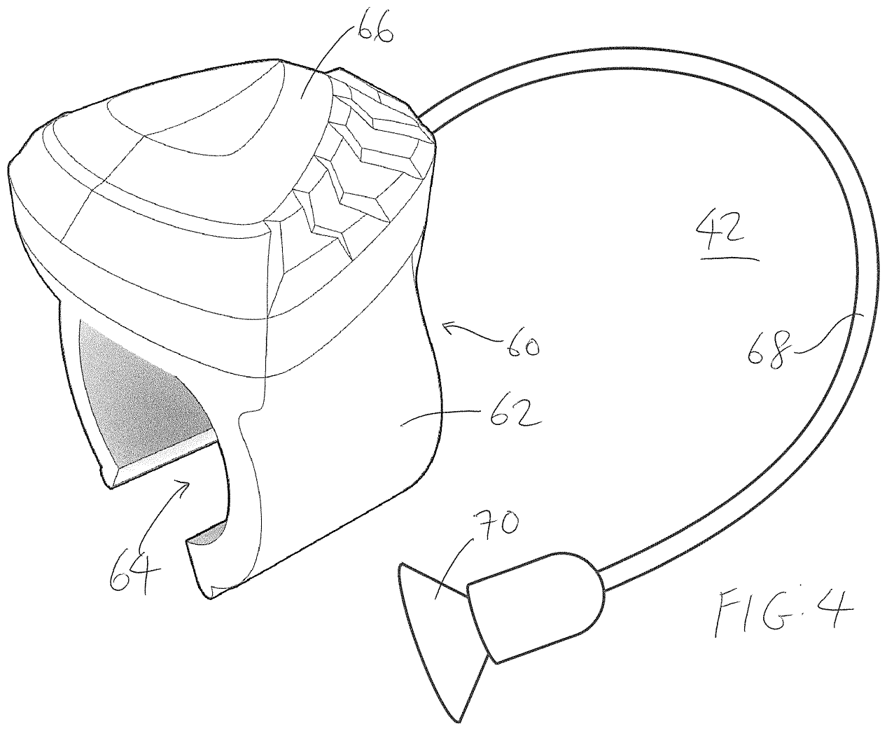

Referring to FIG. 4, the conductive button assemblies 40 are the same, and each conductive button assembly 40 has a clip 60 that has a C-shaped body 62 which is sized and configured to clip on to the handlebar 38 adjacent the grip 36. The C-shaped body 62 has a bore 64 that is sized and configured to receive the handlebar 38. A button 66 is provided on top of the C-shaped body 62, and a connecting wire 68 extends from the button 66 to a suction cup 70. The suction cup 70 is adapted to be removably stuck on to the touchscreen of a conventional smartphone, and is adapted is simulate the effect of a human finger or thumb pressing on a portion of the touchscreen while playing a game. All the components of the conductive button assembly 42 can be made from a conductive material, such as conductive silicone rubber, so that conductive signals from a human finger or thumb can be transferred from the button 66 through the connecting wire 68 to the suction cup 70, and then on to the touchscreen. The conductive silicone rubber is also soft and flexible enough to allow the body 62 to be flexed for gripping the handlebar 38.

The mount 44 includes a curved bar 46 that has a first end connected to a holder 48, and an opposite second end connected to a first clamp part 52 of the clamping section 50. The clamping section 50 has a first curved clamp part 52 and a second curved clamp part 54. The two clamp parts 52 and 54 are curved so as to together define an annular space that is sized and configured to receive the bar of the front frame 26 when the two clamp parts 52 and 54 are wrapped around the bar of the front frame 26. Screws 56 can be used to secure the two clamp parts 52 and 54 together.

The holder 48 includes a fixed support piece 80 that is secured to the first end of the curved bar 46. An adjustable support piece 82 is movably connected to the fixed support piece 80 by connecting bars 84 that extend through both support pieces 80 and 82, and which allow the adjustable support piece 82 to be slid towards and away from the fixed support piece 80. Each support piece 80 and 82 has an end ridge 86 and 88, respectively, each of which is adapted to grip an edge of a smartphone 40. The user can adjust the distance between the ridges 86 and 88 by moving the adjustable support piece 82 towards and away from the fixed support piece 80. This allows smartphones 40 of different sizes to be accommodated in the holder 48. As shown in the FIGS., the holder 48 is positioned in the U-shaped central portion 34.

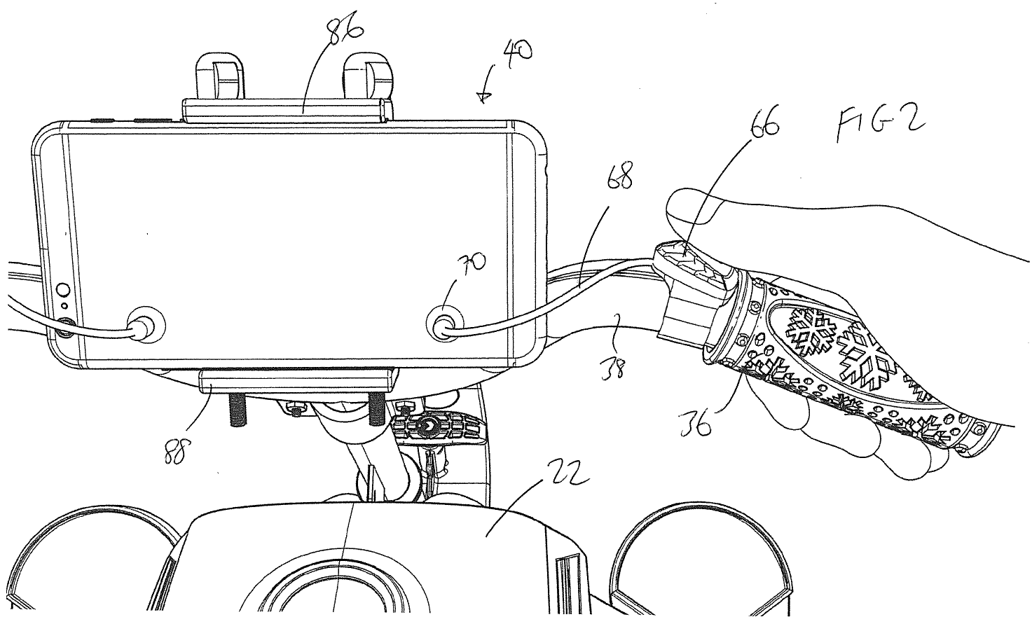

In use, the user secures the mount 44 to the front frame 26 at the location of the central portion 34 so that a smartphone 40 can be mounted at the location of the U-shaped opening in the central portion 34. This is accomplished by wrapping the two clamp parts 52 and 54 around the bar of the front frame 26, and using screws 56 to secure the two clamp parts 52 and 54 together. The smartphone 40 can then be positioned in the holder 48, and the relative positions of the two support pieces 80 and 82 adjusted, to securely hold the smartphone 40 in the holder 48. Next, one conductive button assembly 40 is installed to each handlebar 38 by clipping the C-shaped body 62 around the handlebar 38 so that its bore 64 receives the handlebar 38. The suction cup 70 is then attached to the touchscreen of the smartphone 40 adjacent an edge thereof (see FIG. 2), and the game is ready to be played.

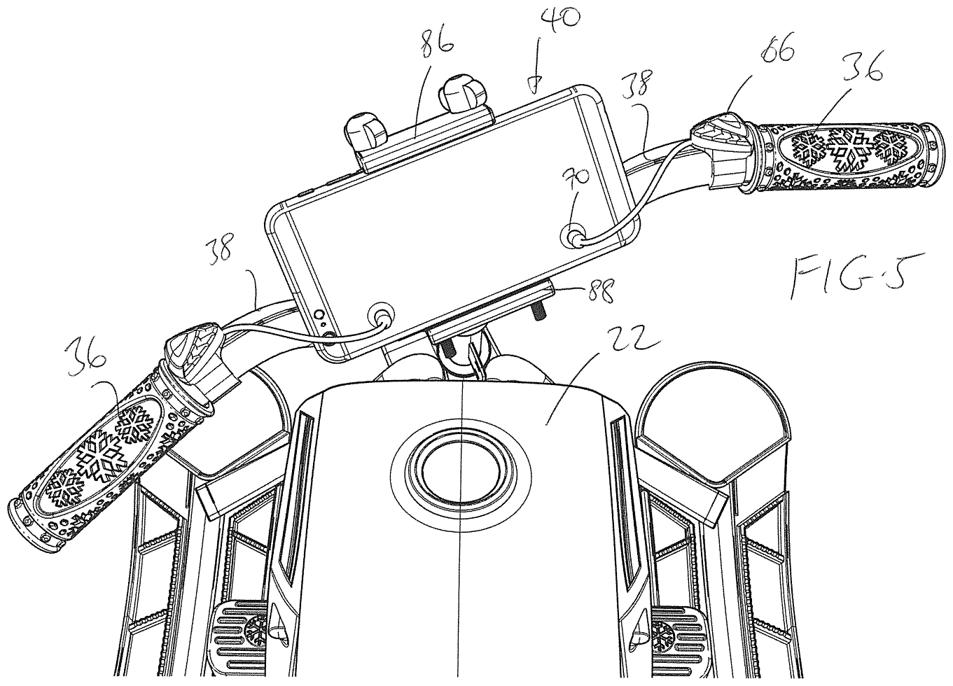

The user then mounts the snow bike 20 and sits on the main body 22, using each of his or her hands to grip a grip 38. The user then starts the game on the smartphone 40 and uses his or her thumbs to press on the button 66 of each conductive button assembly 40 so that conductive signals from the thumbs can be transferred from the button 66 through the connecting wire 68 to the suction cup 70, and then on to the touchscreen. See FIG. 2. The user can manipulate the steering assembly 32 by turning it left and right. See FIG. 5. This provides a more realistic simulation of a game experience, as the user can experience the feeling of being in an actual vehicle that is being steered by the smartphone.

While the description above refers to particular embodiments of the present invention, it will be understood that many modifications may be made without departing from the spirit thereof. The accompanying claims are intended to cover such modifications as would fall within the true scope and spirit of the present invention.

1. A transverse elevator system having generally horizontal and generally vertical components as defined in claim 1, including a horizontal pathway for guiding a plurality of first object vehicles, a generally vertical pathway for guiding at least one second object vehicle, said horizontal pathway including at least one stop at at least one vertical pathway, an object carrying capsule in at least one of the first object passenger vehicles, and means for transferring the capsule from said one first object vehicle at said one stop to one of said second object vehicles when the one first object vehicle is adjacent said vehicle pathway at said one stop, whereby operating mechanisms for the horizontal and vertical pathways remain unaffected as objects are transferred from the horizontal direction to the vertical direction.

2. A transverse elevator system having generally horizontal and generally vertical components as defined in claim 1, said object being a human passenger wherein said extension includes at least one horizontally moveable partition extendable from the vertical pathway into engagement with one first object vehicles when the first object vehicle is at the one stop.

3. A transverse elevator system having generally horizontal and generally vertical components as defined in claim 3, including a plurality of extendable partitions extendable from the vertical pathway into engagement with the one first object vehicle, and rotary locks on a distal portion of the partitions for securing the one passenger vehicle to the vertical pathway to facilitate movement of passengers from the first passenger vehicle in the horizontal pathway to the second passenger vehicle in the vertical pathway.

4. A transverse elevator system having generally horizontal and generally vertical components as defined in claim 1, said object being an human passenger including a plurality of vertical pathways along the horizontal pathway, each with at least one second passenger vehicle in each vertical pathway, and including one stop along the horizontal pathway at each vertical pathway so passengers in the horizontal pathway can transfer to each of the vertical pathways at each of the one stops.

5. A transverse elevator system having generally horizontal and generally vertical components as defined in claim 1, said object being an human passenger, including a plurality of vertical pathways along the horizontal pathway, each with at least one second passenger vehicle in each vertical pathway, and including one stop along the horizontal pathway so passengers in the horizontal pathway can transfer to each of the vertical pathways at each of the one stops.

6. transverse elevator system having generally horizontal and generally vertical components as defined in claim 10, including a plurality of vertical pathways along the horizontal pathway, each with at least one second passenger vehicle in each vertical pathway, and including one stop along the horizontal pathway at each vertical pathway so passengers in the horizontal pathway can transfer to each of the vertical pathways at each of the one stops.

7. A transverse elevator system having generally horizontal and generally vertical components as defined in claim 5, wherein each of said vertical pathways includes a plurality of extensions engageable with the first vehicles in the horizontal pathway.

8. A transverse elevator system having generally horizontal and generally vertical components as defined in claim 1, wherein said extension includes a chute having a floor panel with upstanding side panels and a top panel all extending between the vertical pathways and the first passenger vehicle.

9. A transverse elevator system having generally horizontal and generally vertical components as defined in claim 10, including a plurality of vertical pathways along the horizontal pathway, each with at least one second passenger vehicle in each vertical pathway, and including one stop along the horizontal pathway at each vertical pathway so passengers in the horizontal pathway can transfer to each of the vertical pathways at each of the one stops.

10. A transverse elevator system having generally horizontal and generally vertical components, comprising: a horizontal pathway for guiding a first passenger vehicle, a generally vertical pathway for guiding a second passenger vehicle, said horizontal pathway including a stop at said vertical pathway, a passenger carrying capsule in said first passenger vehicle in said first passenger vehicle, and means for transferring the capsule from said first passenger vehicle at said stop to said second passenger vehicle when the first passenger vehicle is adjacent said vertical pathway at said stop, whereby operating mechanisms for the horizontal and vertical pathways remain unaffected as passengers are transferred from the horizontal to the vertical direction.

11. A transverse elevator system having generally horizontal and generally vertical components as defined in claim 10, wherein the capsule is a 360 degree envelope surrounding the passengers therein.

12. A transverse elevator system having generally horizontal and generally vertical components as defined in claim 9, wherein a capsule is provided in each of the first passenger vehicles and each of the second passenger vehicles.

13. A transverse elevator system having generally horizontal and generally vertical components as defined in claim 10, including a traction drive assembly for the capsule moveably mounted at least in part on an upper surface of the capsule.

14. transverse elevator system having generally horizontal and generally vertical components as defined in claim 12, including an extendible partition from the vertical pathway engageable with the first vehicle to hold said first vehicle in a locked position, said traction drive being engageable with the partition to drive the capsule in the first vehicle into the second vehicle.

15. A transverse elevator system generally horizontal and generally vertical components as defined in claim 13, wherein the traction drive includes an endless belt.

16. A transverse elevator system having generally horizontal and generally vertical components as defined in claim 13, wherein said extension includes at least one horizontally moveable partition extendable from the vertical pathway into engagement with one first passenger vehicles when the first passenger vehicle is at the one stop.

17. A transverse elevator system having generally horizontal and generally vertical components as defined in claim 13, including a plurality of extendable partitions extendable from the vertical pathway into engagement with the one first passenger vehicle, and rotary locks on a distal portion of the partitions for securing the one passenger vehicle to the vertical pathway to facilitate movement of passengers from the first passenger vehicle in the horizontal pathway to the second passenger vehicle in the vertical pathway.

18. A transverse elevator system having generally horizontal and generally vertical components as defined in claim 13, including a plurality of vertical pathways along the horizontal pathway, each with at least one second passenger vehicle in each vertical pathway, and including one stop along the horizontal pathway at each vertical pathway so passengers in the horizontal horizontal pathway at each vertical pathway so passengers in the horizontal pathway can transfer to each of the vertical pathways at each of the one stops, wherein each of said vertical pathways includes a plurality of extensions engageable with the first vehicles in the horizontal pathway.

19. A transverse elevator system having generally horizontal and generally vertical components, comprising: a horizontal pathway for guiding a plurality of first passenger vehicles, a generally vertical pathway for guiding at least one second passenger vehicle, said horizontal pathway including at least one stop at at least one vertical pathway. wherein the stop includes a side track from the horizontal pathway to said one horizontal pathway to the one vertical pathway permitting the first vehicles to pass the vertical pathway on the horizontal pathway, when a first vehicle is on the side track at said one stop to minimize first vehicle slowing by first vehicles located at the stop at the vertical pathway.

20. A transverse elevator system having generally horizontal and generally vertical components, as defined in claim 18, wherein the side track includes an exit switch on the horizontal pathway connected to a side inlet pathway connected sequentially to straight stop pathway defining said one stop.

21. A transverse elevator system having generally horizontal and generally vertical components, as defined in claim 18, including a control for modifying the locations of one or more first passenger vehicles along the horizontal pathway near the side track to permit the first passenger vehicle in the side track to reenter the first pathway
